(19) United States
(12) Patent Application Publication
(10) Pub. No.: US 2023/0303278 A1
(43) Pub. Date: Sep. 28, 2023

(54) LID APPARATUS AND CANNING SYSTEM

(71) Applicant: Alpha Brewing Operations, Lincoln, NE (US)

(72) Inventor: Matthew Charles Rennerfeldt, Lincoln, NE (US)

(21) Appl. No.: 18/191,126

(22) Filed: Mar. 28, 2023

Related U.S. Application Data
(60) Provisional application No. 63/324,326, filed on Mar. 28, 2022.

(51) Int. Cl. B65B 7/28; B67C 7/00; B67C 3/26

(52) U.S. Cl. CPC B65B 7/2807; B67C 7/00; B67C 3/26

(57) ABSTRACT

A lid apparatus includes a lid releaser plate that includes a plurality of lid apertures and a actuator coupled to the lid releaser plate that moves the lid releaser plate between a lid lock position and a lid release position. Each lid aperture of the lid releaser plate abuts a bottom of a corresponding stack of a plurality of lids. A canning system includes a filling station for filling a plurality of containers with product, a lid placement station, and a push plate configured to move the plurality of containers from the filling station to the lid placement station. The lid placement station includes a lid apparatus.

### BACKGROUND

Many industrial canning systems, particularly those used by small batch beer brewers and novelty drink makers, currently use a “lid pick” system in which a container is continuously moved in a line that passes underneath a lid apparatus that holds lids. When the container moves underneath and past the lid apparatus, a single lid from the lid apparatus is caught by a top of the container and released from the lid apparatus. However, there are several drawbacks to these lid pick systems. One drawback is that the container must be moved underneath the lid apparatus at a specific location and be moving at the correct speed. If the container is not moved across the specific location underneath the lid apparatus and/or moved at an incorrect speed, the lid may fail to be placed correctly on top of the container, and that container will not have the lid seamed correctly to the top of the container. This can lead to spillage (which has to be cleaned), production will have to be stopped to remove the container and/or place the lid on the container correctly, and the system will need to be calibrated to make sure other containers are moved underneath the lid apparatus at the specific location and the correct speed. Another drawback is that production must be stopped periodically to refill the lid apparatus with lids.

### BRIEF SUMMARY

A canning system and a lid apparatus are provided. Advantageously, the lid apparatus enables multiple containers to simultaneously receive a lid for seaming without shutting down production of the canning system to refill lid sleeves of the lid apparatus with additional lids. Furthermore, the canning system positions containers in a lid placement station that includes the lid apparatus without the need for extensive calibration and stopping of production to calibrate the canning system that is normally required for placing lids on containers. The integration of the lid apparatus into the canning system described herein results in a canning system that has less down time for calibration and refilling of lids.

A lid apparatus includes a lid releaser plate that includes a plurality of lid apertures and an actuator to the lid releaser plate that moves the lid releaser plate between a lid lock position and a lid release position. Each lid aperture of the lid releaser plate abuts a bottom of a corresponding stack of a plurality of lids.

In some cases, the lid apparatus further includes a plurality of lid sleeves. Each lid sleeve is configured to hold the corresponding stack of the plurality of lids. In some cases, the lid apparatus further includes a plurality of buffer lid storage receptacles. Each buffer lid storage receptacle is coupled to a corresponding lid sleeve of the plurality of lid sleeves and is configured to hold a buffer portion of the corresponding stack of the plurality of lids from the corresponding lid sleeve of the plurality of lid sleeves. In some cases, for each lid sleeve of the plurality of lid sleeves and its corresponding buffer lid storage receptacle of the plurality of buffer lid storage receptacles, when the actuator moves the lid releaser plate to the lid release position, a first lid of the buffer portion of the corresponding stack of the plurality of lids is released from that buffer lid storage receptacle onto a container and a second lid of the corresponding stack of the plurality of lids moves from the corresponding lid sleeve to that buffer lid storage receptacle. In some cases, during operation, each of the plurality of lid sleeves is detachable from its corresponding buffer lid storage receptacle for refilling with additional lids.

In some cases, the lid releaser plate directs a single lid from each corresponding stack of the plurality of lids to be released through the lid aperture of the plurality of lid apertures of the lid releaser plate. In some cases, the actuator moves the lid releaser plate to the lid release position for a period of time sufficient for the single lid from each corresponding stack of the plurality of lids to be released. In some cases, movement of the lid releaser plate from the lid lock position to the lid release position causes the single lid from each corresponding stack of the plurality of lids to be released by separating the single lid from each from each corresponding stack of the plurality of lids. In some cases, when the actuator moves the lid releaser plate to the lid lock position, the single lid from each corresponding stack of the plurality of lids is prevented from being released through the lid aperture of the plurality of lid apertures of the lid releaser plate.

A canning system includes a filling station for filling a plurality of containers with product, a lid placement station, and a push plate configured to move the plurality of containers from the filling station to the lid placement station. The lid placement station includes a lid apparatus configured to simultaneously place a single lid on each of the plurality of containers in the lid placement station.

In some cases, the push plate includes a first plate coupled to a first actuator. In some cases, the first plate is pushed, via the first actuator, against a side of each of the plurality of containers from the filling station to the lid placement station. In some cases, the push plate includes a second plate coupled to a second actuator. In some cases, the second plate is positioned, via the second actuator, against the side of each of the plurality of containers after the first plate pushes the side of each of the plurality of containers from the filling station to the lid placement station. In some cases, the canning system further includes an inert gas manifold configured to simultaneously release inert gas over each of the plurality of containers in the lid placement station prior to the lid apparatus simultaneously placing the lid on each of the plurality of containers.

In some cases, the canning system further includes a canning system controller that sends a first signal to the first actuator to move the lid releaser plate of the lid apparatus from a lid lock position to a lid release position to simultaneously place the single lid on each of the plurality of containers in the lid placement station. In some cases, the canning system controller sends a second signal to the second actuator to push the first plate of the push plate against a side of each of the plurality of containers to move the plurality of containers from the filling station to the lid placement station after the plurality of containers have been filled with product by the filling station. In some cases, the canning system controller sends a third signal to the third actuator to position a second plate of the push plate against the side of each of the plurality of containers after the first push plate pushes the side of each of the plurality of containers to move each of the plurality of containers from the filling station to the lid placement station. In some cases, the canning system controller sends a fourth signal to the inert gas manifold to simultaneously release inert gas over each of the plurality of containers in the lid placement station prior to sending the first signal to move the lid releaser plate of the lid apparatus from the lid lock position to the lid release position. In some cases, the canning system controller sends a fifth signal to the container removal apparatus to remove the plurality of containers from the lid placement station.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a canning system including a lid apparatus.

FIGS. 2A-2C illustrate perspective views of a canning system including a lid apparatus.

FIGS. 3A-3C illustrate top-down views containers cycling through a canning system.

FIG. 4 illustrates a method of filling and seaming containers using a canning system.

FIGS. 5A-5C illustrate views of a lid releaser plate of a lid apparatus.

FIGS. 6A-6E illustrate various views of a lid apparatus.

FIG. 7 illustrates a controller used to provide instructions for enabling the functionality described herein.

### DETAILED DESCRIPTION

A canning system and a lid apparatus are provided. Advantageously, the lid apparatus enables multiple containers to simultaneously receive a lid for seaming without shutting down production of the canning system to refill lid sleeves of the lid apparatus with additional lids. Furthermore, the canning system positions containers in a lid placement station that includes the lid apparatus without the need for extensive calibration and stopping of production to calibrate the canning system that is normally required for placing lids on containers. The integration of the lid apparatus into the canning system described herein results in a canning system that has less down time for calibration and refilling of lids.

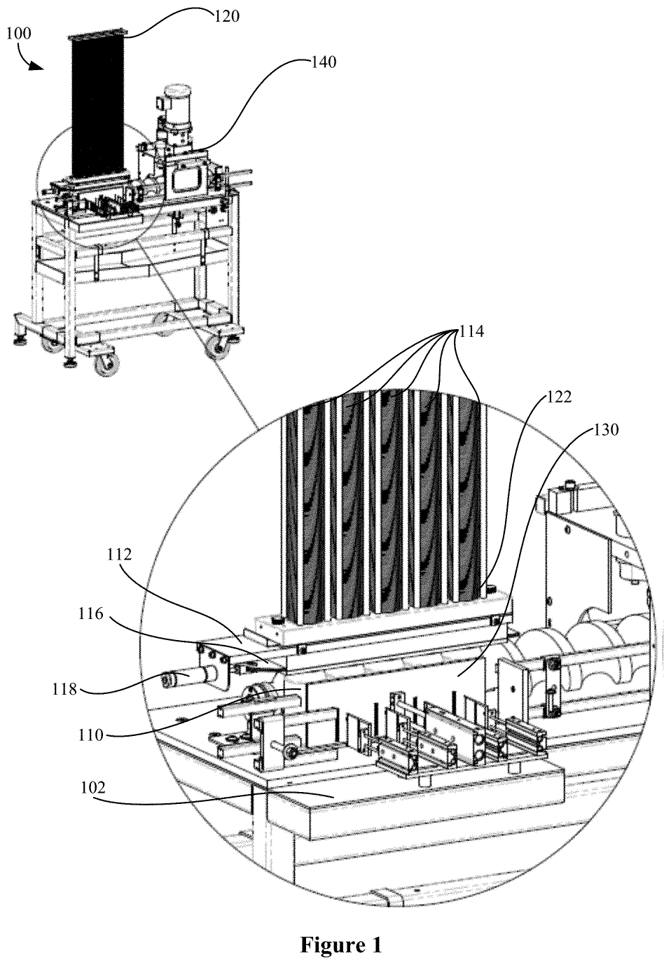

FIG. 1 illustrates a canning system including a lid apparatus. Referring to FIG. 1, a canning system 100 includes a filling station 102 for filling a plurality of containers with a product, a lid placement station 110 that includes a lid apparatus 112 configured to simultaneously place single a lid on each of the plurality of containers in the lid placement station 110, and a push plate 130 configured to move the plurality of containers from the filling station 102 to a lid placement station 110.

In some cases, the lid apparatus 112 includes a plurality of lid sleeves 114, a lid releaser plate 116, and an actuator 118 coupled to the lid releaser plate 116 that moves the lid releaser plate 116 between a lid lock position (e.g., a position in which no lids are released from the lid sleeve) and a lid release position (e.g., a position in which a single lid from a corresponding stack of the plurality of lids is released from each lid sleeve at a time). In some cases, each of the plurality of lid sleeves 114 includes a refill end 120 (e.g., where a corresponding stack of the plurality of lids are inserted into the lid sleeve) and a release end 122 (e.g., where a single lid of the corresponding stack of the plurality of lids is released from each lid sleeve at a time). Advantageously, by having a plurality of lid sleeves 114, more containers are filled before replenishment of lids is required (depending on how many lid sleeves there are) versus a lid apparatus 112 that only uses a single lid sleeve. In some cases, in lieu of a plurality of lid sleeves, a single lid sleeve and/or lid sleeve compartment can be used in combination with a lid distributor that directs a single lid to each aperture (not illustrated in this figure) of the lid releaser plate 116 for placement of a single lid onto a top of each of the plurality of containers in the lid placement station 110. In some cases, the canning system 100 includes other features, such as a seamer assembly 140 for seaming the single lid placed on each of the plurality of containers.

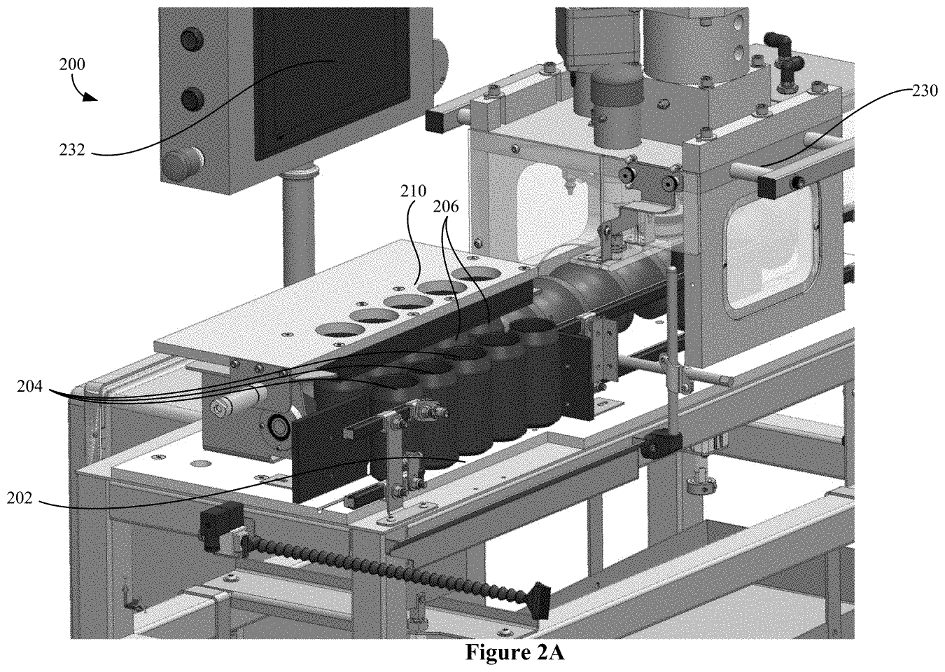

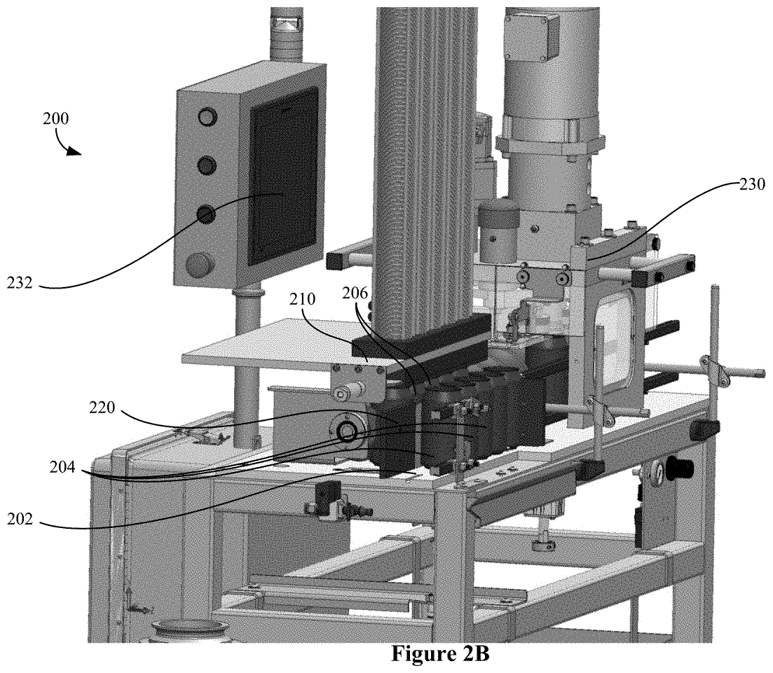

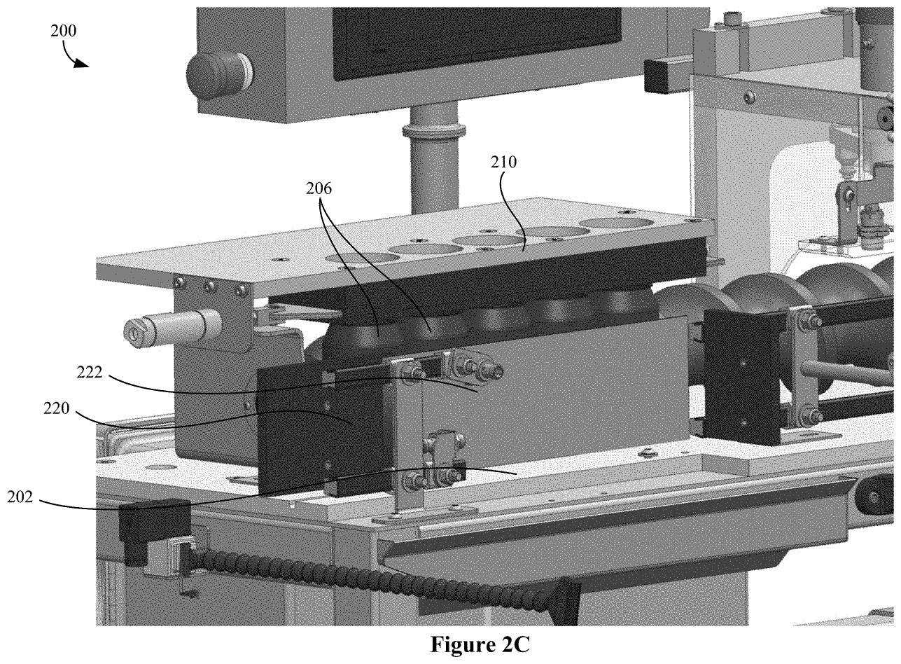

FIGS. 2A-2C illustrate perspective views of a canning system including a lid apparatus. It should be understood that some features that would normally be included may be excluded in these figures so that other features are more easily viewable. Referring to FIGS. 2A-2C, a canning system 200 includes a filling station 202 having a first plurality of containers 204, a lid placement station 210 having a second plurality of containers 206, and a push plate 220 configured to move the first plurality of containers 204 from the filling station 202 to the lid placement station 210 (e.g., once the second plurality of containers 206 have been removed from the lid placement station 210 and the first plurality of containers 204 have been filled with product).

In some cases, the push plate 220 includes a first plate coupled to a first actuator (e.g., not visible in these figures). In some cases, the first plate of the push plate 220 is pushed, via the first actuator, against a side of each of the first plurality of containers 204 from the filling station 202 to the lid placement station 210. In some cases, the push plate 220 includes a second plate 222 coupled to a second actuator (e.g., not visible in these figures). In some cases, the second plate 222 is positioned, via the second actuator, against the side of each of the first plurality of containers 204 (e.g., as illustrated in FIG. 2C) after the first plate pushes the side of each of the first plurality of containers 204 from the filling station 202 to the lid placement station 210. For example, after the first plurality of containers 204 are filled with product and the second plurality of containers 206 have been removed from the lid placement station 210, the first plate of the push plate 220 pushes the first plurality of containers 204 into the lid placement station 210. Then, the first plate of the push plate 220 moves back (e.g., via the first actuator) and the second plate 222 of the push plate 220 is positioned against the side of each of the first plurality of containers 204 to hold the first plurality of containers 204 in the correct position to receive lids in the lid placement station 210.

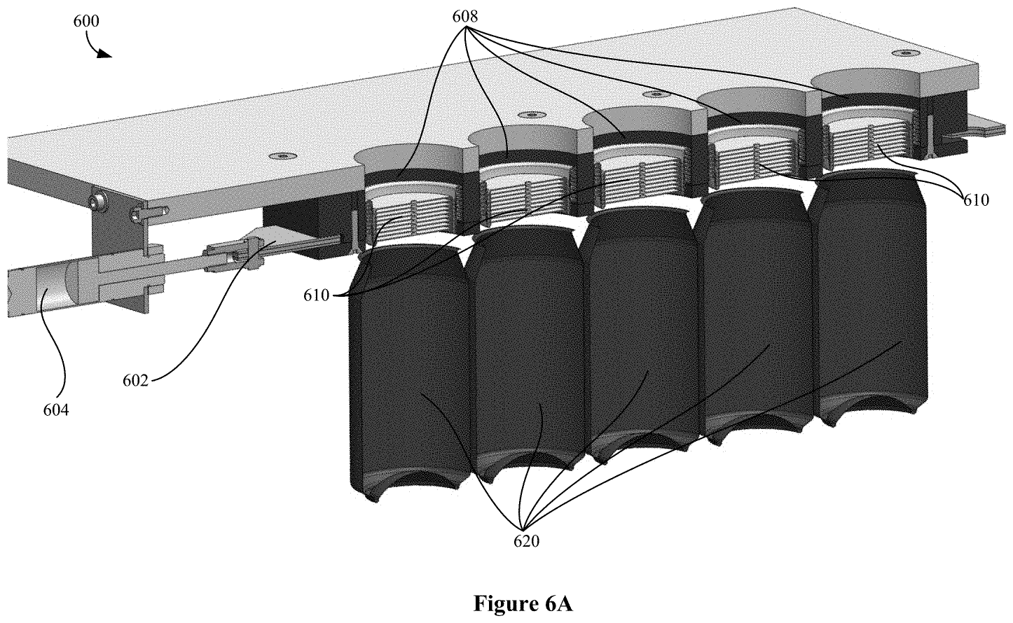

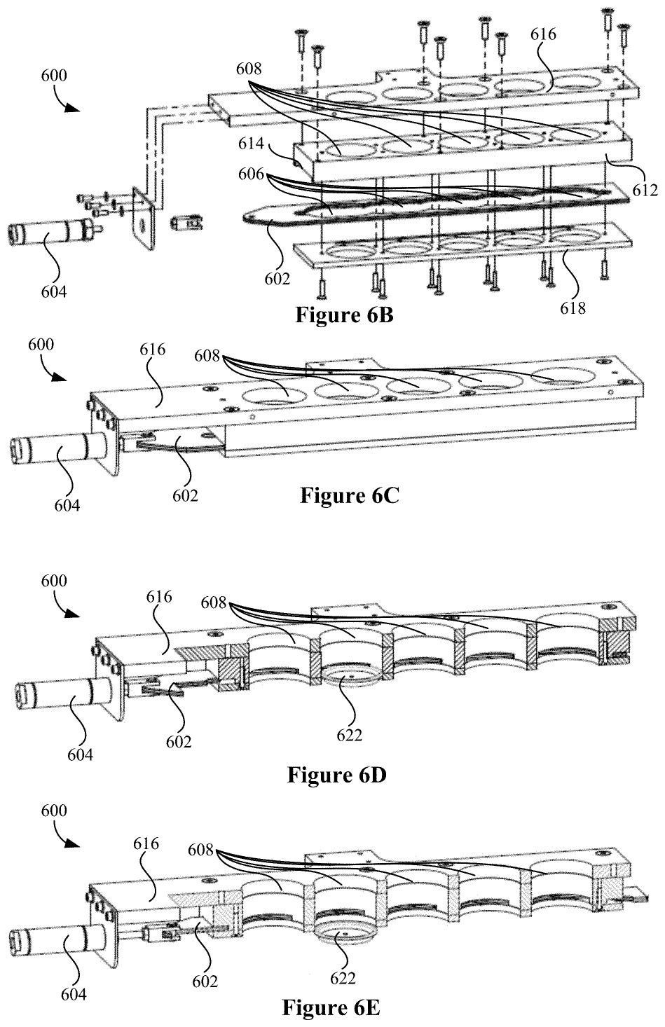

In some cases, the canning system 200 includes other features, such as a seamer assembly 230 for seaming the single lid placed on each of the plurality of containers and/or a display/user interface 232 for receiving user input (e.g., to adjust settings of the canning system 200). In some cases, the canning system 200 includes an inert gas manifold configured to simultaneously release inert gas (e.g., carbon dioxide) over each of the first and/or second plurality of containers 204, 206 in the lid placement station 210 prior to the lid apparatus simultaneously placing a lid on each of the first and/or second plurality of containers 204, 206. For example, the inert gas manifold may release a relatively small amount of inert gas over each container immediately preceding the placement of the lid on each container. In some cases, the inert gas manifold may be integrated into a lid apparatus (e.g., as explained in further detail with respect to FIGS. 6A-6E), allowing for a smaller amount of inert gas to be used than in existing canning systems, saving valuable resources such as money (e.g., the cost of the inert gas), employee time (e.g., the time it takes to replace empty inert gas tanks), and storage for the inert gas tanks (e.g., smaller inert gas tanks may be used to achieve placing inert gas in the same amount of containers as with larger inert gas tanks in existing canning systems).

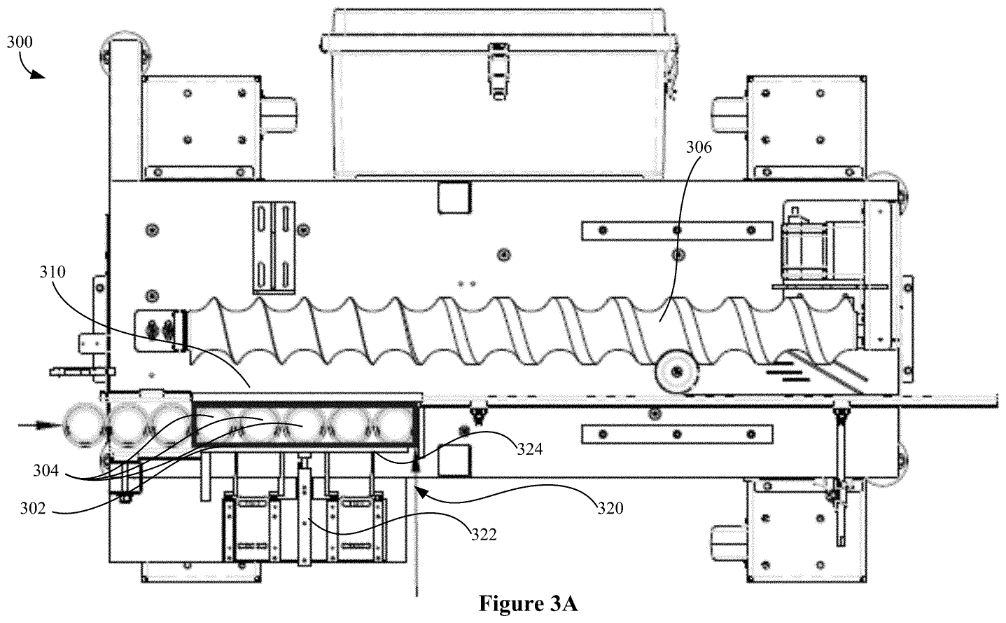

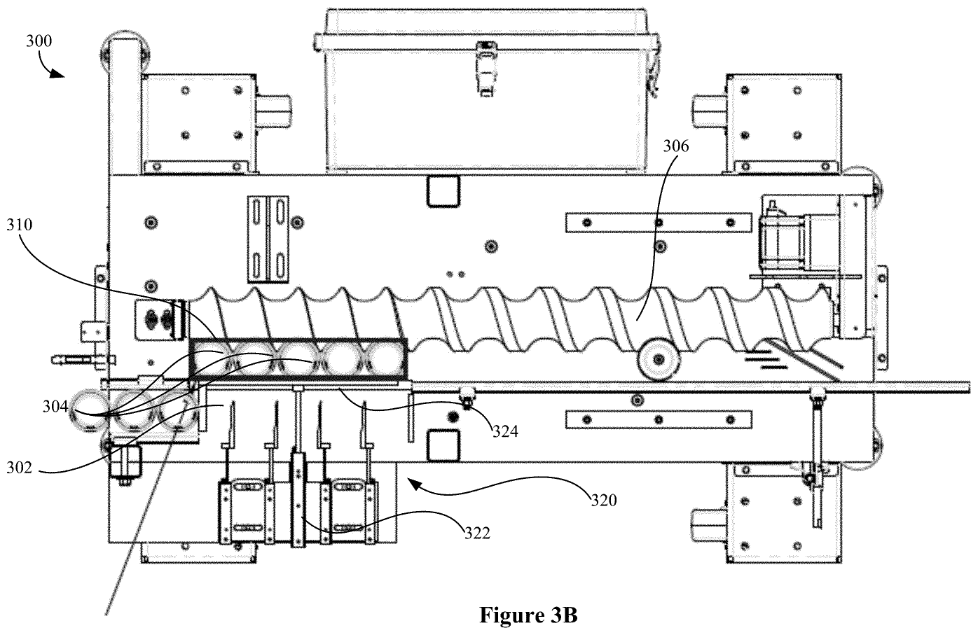

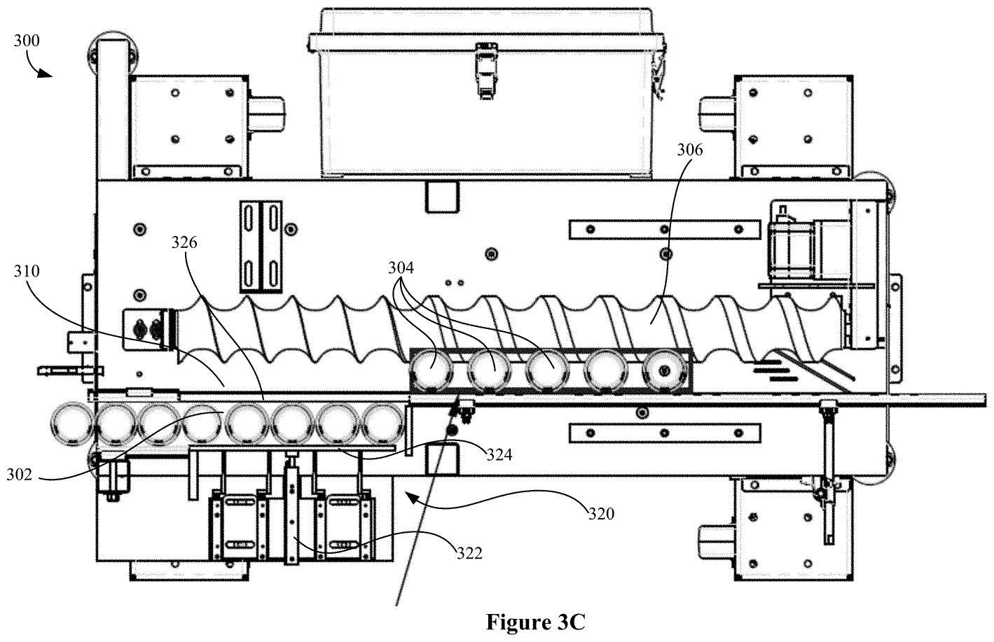

FIGS. 3A-3C illustrate top-down views containers cycling through a canning system. Referring to FIGS. 3A-3C, a canning system 300 includes a filling station 302 for filling a plurality of containers 304 with a product, a lid placement station 310 that includes a lid apparatus (not illustrated in these figures) configured to simultaneously place single a lid on each of the plurality of containers 304 in the lid placement station 310, and a push plate 320 configured to move the plurality of containers 304 from the filling station 302 to a lid placement station 310. In some cases, the push plate 320 includes a first actuator 322 coupled to a first plate 324, and a second actuator (not illustrated in these figures) coupled to a second plate 326.

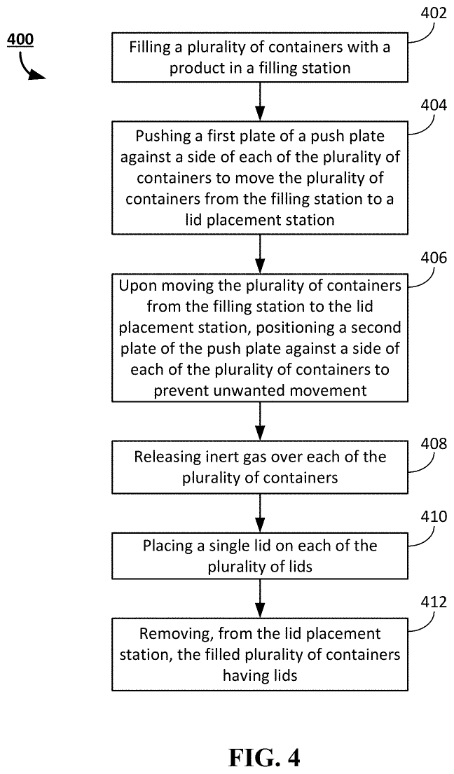

FIG. 4 illustrates a method of filling and seaming containers using a canning system. In some cases, one or more of the following steps illustrated in FIGS. 3A-3C and FIG. 4 are carried out by the various components described herein based on signals received from a single canning system controller or multiple controllers, with each carrying out a specific task(s) and/or step(s) illustrated in FIGS. 3A-3C and FIG. 4. Referring to FIG. 3A, the plurality of containers 304 first enter the filling station 302, where the plurality of containers 304 are subsequently filled with a product. In some cases, a canning system controller sends one or more signals to the filling station 302 to control the amount of product as well as the speed at which the product is dispensed into the plurality of containers 304. In some cases, a timer and/or sensor (e.g., weight sensor and/or proximity sensor) can be used to facilitate controlling the amount and/or speed at which the product is dispensed into the plurality of containers 304. Referring to FIG. 4, the method 400 includes filling (402) a plurality of containers 304 with a product in a filling station.

Referring to FIG. 3B, after filling the plurality of containers with product, the first actuator 322 of the push plate 320 pushes the first plate 324 of the push plate 320 against a side of each of the plurality of containers 304 to move the plurality of containers from the filling station 302 to the lid placement station 310. In some cases, the canning system controller sends a signal to the first actuator 322 of the push plate 320 to push the first plate 324 of the push plate 320 against a side of each of the plurality of containers 304 to move the plurality of containers from the filling station 302 to the lid placement station 310. In some cases, a timer and/or proximity sensor can be used to facilitate controlling the distance and/or placement that the first plate 324 of the push plate 320 is pushed against the side of each of the plurality of containers 304 to move the plurality of containers 304 from the filling station 302 to the lid placement station 310. Referring back to FIG. 4, the method 400 further includes pushing (404) a first plate of a push plate against a side of each of the plurality of containers to move the plurality of containers from the filling station to a lid placement station.

Referring back to FIG. 3B, once the plurality of containers 304 are pushed into the lid placement station 310, the second actuator of the push plate 320 positions the second plate 326 of the push plate 320 against the side of each of the plurality of containers 304 to prevent the plurality of containers 304 from (unintentionally) exiting the lid placement station 310 and/or to prevent unwanted movement from any of the plurality of containers 304. In some cases, the canning system controller sends a signal to the second actuator of the push plate 320 to position the second plate 326 of the push plate 320 against the side of each of the plurality of containers 304. In some cases, the first plate 324 of the push plate 320 is moved back to its original position (e.g., to a side of the filling station 302 as illustrated in FIG. 3A) prior to and/or simultaneously as the positioning of the second plate 326 of the push plate 320 against the side of each of the plurality of containers 304 (e.g., based on a signal from the canning system controller). In some cases, a timer and/or proximity sensor can be used to facilitate positioning of the second plate 326 of the push plate 320 against the side of each of the plurality of containers 304. Referring back to FIG. 4, the method 400 further includes, upon moving the plurality of containers from the filling station to the lid placement station, positioning (406) a second plate of the push plate against the side of each of the plurality of containers to prevent the plurality of containers from (unintentionally) exiting the lid placement station and/or to prevent unwanted movement from any of the plurality of containers.

Referring back to FIG. 3B, in some cases, prior to and/or during the placement of the single lid on each of the plurality of containers 304 in the lid placement station 310, an inert gas manifold (not illustrated) simultaneously releases inert gas over each of the plurality of containers 304 in the lid placement station 310. In some cases, the canning system controller sends a signal to the inert gas manifold to simultaneous release inert gas over each of the plurality of containers 304 in the lid placement station 310. In some cases, an inert gas sensor (e.g., capacity sensor) can be used to provide an indication of a quantity of inert gas that is left in an inert gas tank. Referring back to FIG. 4, the method 400 further includes releasing (408) inert gas over each of the plurality of containers.

Referring back to FIG. 3B, after the second plate 326 of the push plate 320 is positioned against the side of each of the plurality of containers 304 (and simultaneous to or after releasing inert gas over each of the plurality of containers 304, a lid apparatus (e.g., as described in detail with respect to FIGS. 6A-6E) places a single lid on each of the plurality of containers 304 in the lid placement station 310. In some cases, the canning system controller sends a signal to the lid apparatus to place a single lid on each of the plurality of containers 304 in the lid placement station 310. In some cases, a timer and/or one or more lid sleeve sensors (e.g., a capacity sensor) can facilitate placing of a lid on each of the plurality of containers 304 by providing an indication of a quantity of lids that are left in a given lid sleeve. Referring back to FIG. 4, the method 400 further includes, upon positioning the second plate of the push plate (and/or releasing inert gas over each of the plurality of containers), placing (410) a single lid on each of the plurality of lids.

Referring to FIG. 3C, in some cases, the canning system 300 further includes a container removal apparatus, such as a feed screw 306, conveyor belt, and/or index wheel, to remove the filled plurality of containers 304 having lids from the lid placement station 310. For example, as illustrated in FIG. 3C, the canning system 300 may remove the filled plurality of containers 304 having lids from the lid placement station 310, via a feed screw 306/container removal apparatus, to a seamer assembly for seaming the lids to the plurality of containers 304. In some cases, the canning system controller sends a signal to the container removal apparatus to remove the filled plurality of containers 304 having lids from the lid placement station 310. In some cases, a timer and/or proximity sensor can be used to facilitate removal of filled containers having lids 304 from the lid placement station 310. Referring back to FIG. 4, the method 400 further includes removing (412), from the lid placement station, the filled plurality of containers having lids.

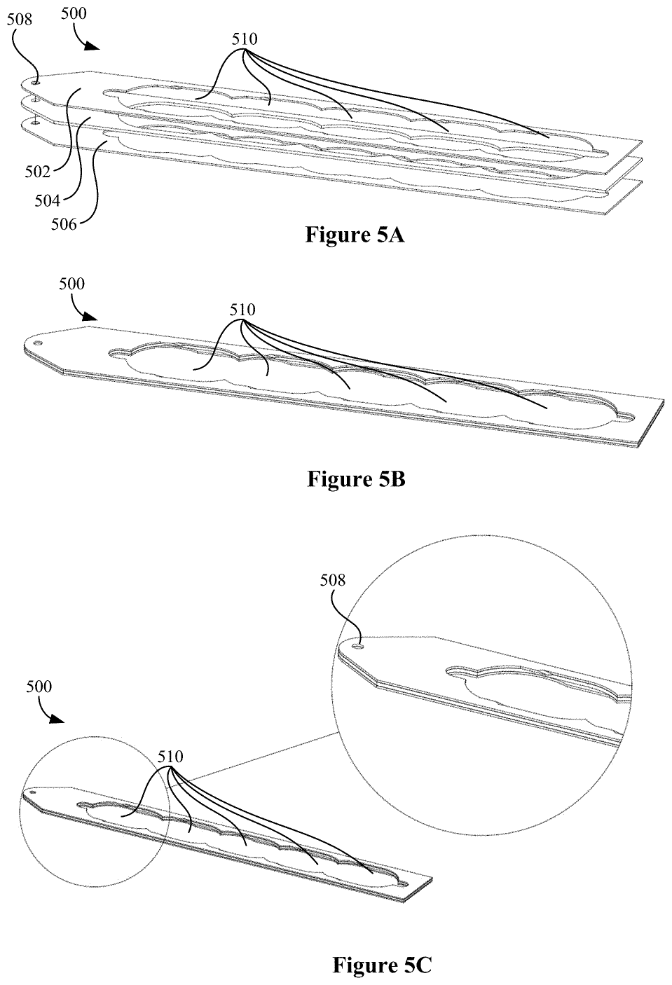

FIGS. 5A-5C illustrate views of a lid releaser plate of a lid apparatus. Referring to FIG. 5A, an exploded view of a lid releaser plate 500 includes three layers 502, 504, 506, with each layer 502, 504, 506 having a coupling aperture 508 for coupling to an actuator (e.g., as illustrated in FIGS. 6A-6E). In some cases, the lid releaser plate 500 can include two or more layers. In some cases, the lid releaser plate 500 can be made of a single layer (e.g., a single plate). It should be understood that the number of layers are a manufacturing choice based on the strength of the material necessary to move back and forth between a lid lock position and a lid release position to release a single lid on the plurality of containers in the lid placement station.

Referring to FIGS. 5A-5C, a lid releaser plate 500 further includes a plurality of lid apertures 510 that are capable of releasing a single lid of a plurality of lids from each of the plurality of lid sleeves (e.g., large enough for a single lid to fit through). In the lid lock position, the plurality of lid apertures 510 are not aligned with the plurality of lids (e.g., above the lid releaser plate 500) such that a lid cannot be released through each of the plurality of lid apertures 510. In the lid release position, the plurality of lid apertures 510 are aligned with the plurality of lids such that a lid is released through each of the plurality of lid apertures 510. In some cases, moving the lid releaser plate 500 from the lid lock position to the lid release position causes the lid releaser plate to “catch” a single lid for each corresponding apertures of the plurality of lid apertures 510 and allow (and in some cases, force) the lids through each of the plurality of apertures 510 and onto a filled container.

In some cases, a number of the plurality of lid apertures 510 is equal to a number of the plurality of lid sleeves (e.g., for each lid aperture 510 a corresponding lid sleeve is included in a lid apparatus). Although five lid apertures 510 are illustrated in these figures, more or less lid apertures 510 may be included. For example, a lid releaser plate 500 may include as little as two lid apertures 510. In some cases, the lid releaser plate 500 may include three or more lid apertures 510. It should be understood that the number of lid apertures 510 corresponds to the number of containers that can simultaneously receive a single lid of the plurality of lids of the plurality of lid sleeves at a time.

FIGS. 6A-6E illustrate various views of a lid apparatus. Specifically, FIGS. 6A, 6C, and 6D illustrate the lid releaser plate 602 of the lid apparatus 600 in the lid lock position, FIG. 6E illustrates the lid releaser plate 602 of the lid apparatus 600 in the lid release position, and FIG. 6B illustrates an exploded view of the lid apparatus 600. Although not illustrated in FIGS. 6A-6E, a plurality of lid sleeves can also be included to hold a corresponding stack of a plurality of lids.

Referring to FIGS. 6A-6E, a cross-sectional view of a lid apparatus 600 includes a lid releaser plate 602 and an actuator 604 coupled to the lid releaser plate 602 that moves the lid releaser plate 602 between a lid lock position and a lid release position. The lid releaser plate 602 includes a plurality of lid apertures (e.g., 606 as illustrated in FIG. 6B). Each lid aperture 606 abuts a bottom of a corresponding stack of a plurality of lids.

In some cases, the lid releaser plate 602 directs a single lid from each corresponding stack of the plurality of lids from each of the plurality of lid sleeves to be released through each lid aperture 606 of the plurality of lid apertures of the lid releaser plate 602. In some cases, the actuator 604 moves the lid releaser plate 602 to the lid release position for a period of time sufficient for the single lid of from each corresponding stack of the plurality of lids to be released (e.g., through each lid aperture of the plurality of lid apertures 606 of the lid releaser plate 602). In some cases, movement of the lid releaser plate 602 from the lid lock position to the lid release position (e.g., via the actuator 604) causes the single lid from each corresponding stack of the plurality of lids to be released (e.g., through each lid aperture of the plurality of lid apertures 606 of the lid releaser plate 602) by separating a single lid from each corresponding stack of the plurality of lids (e.g., by catching the single lid). In some cases, when the actuator 604 moves the lid releaser plate 602 to the lid lock position, the single lid from each corresponding stack of the plurality of lids is prevented from being released through the lid aperture of the plurality of lid apertures 606 of the lid releaser plate 602.

In some cases, the lid apparatus 600 further includes a plurality of buffer lid storage receptacles 608. Each buffer lid storage receptacle 608 is coupled to a corresponding lid sleeve of the plurality of lid sleeves. Each of the plurality of buffer lid storage receptacles 608 is configured to hold a buffer portion 610 of the corresponding stack of the plurality of the plurality of lids from the corresponding lid sleeve of the plurality of lid sleeves. In some cases, for each lid sleeve of the plurality of lid sleeves and its corresponding buffer lid storage receptacle of the plurality of buffer lid storage receptacles 608, when the actuator 604 moves the lid releaser plate 602 to the lid release position, a first lid of the buffer portion of the corresponding stack of the plurality of lids is released from that buffer lid storage receptacle onto a container and a second lid of the corresponding stack of the plurality of lids moves from the corresponding lid sleeve to that buffer lid storage receptacle. In other words, as a lid from the buffer portion of the corresponding stack of lids is released through the lid aperture of the plurality of lid apertures 606, a lid from the corresponding lid sleeve drops into that buffer lid storage receptacle. In some cases, during operation, each of the plurality of lid sleeves is detachable from its corresponding buffer lid storage receptacle for refilling with additional lids. Advantageously, due to the ability to detach each of the plurality of lid sleeves from its corresponding buffer lid storage receptacle and the buffer portion in each corresponding buffer lid storage receptacle, the lid apparatus 600 provides the ability to refill lids without ever shutting down production to refill lid sleeves with additional lids. In some cases, a second set of a plurality of lid sleeves can be utilized by a user to fill with lids while the machine is running so that when the (first) plurality of lid sleeves runs out of lids, the user can detach the (first) plurality of lid sleeves and replace them with the second plurality of lid sleeves while the lid apparatus 600 provides lids to containers from a buffer portion in each corresponding buffer lid storage receptacle, enabling the canning system to continue production without stoppage. In some cases, the user can be alerted to the (first) plurality of lid sleeves being empty via a capacity sensor that senses that the (first) plurality of lid sleeves are empty and provides an indication (e.g., a light) that the (first) plurality of lid sleeves are empty and ready to be replaced.

Referring specifically to FIG. 6B, the plurality of buffer lid storage receptacles 608 can be formed within a buffer storage plate 612 of the lid apparatus 600. The buffer storage plate 612 can also have a groove 614 to allow the lid releaser plate 602 to move between the lid lock position and the lid release position. The lid apparatus 600 can also include a structure plate 616 that aligns couples to each of the plurality of lid sleeves and their corresponding buffer lid storage receptacles 608. The structure plate 616 can also be used to align the actuator 604 with the lid releaser plate 602. The lid apparatus can also include a lid alignment plate 618 underneath the lid releaser plate 602 to ensure the lids released through the plurality of lid apertures 606 of the lid releaser plate 602 are placed correctly onto the plurality of containers.

Referring to FIG. 6A, in this embodiment, five containers 620 are positioned underneath the lid apparatus 600 to receive a lid. The number of containers 620 that can simultaneously receive a lid is a design choice; and the number of containers 620 that can simultaneously receive a lid can be as little as two and as many as fifty. It should be understood that the corresponding features (e.g., number of the plurality of lid sleeves, number of the plurality of apertures 606 of the lid releaser plate 602, number of buffer lid storage receptacles 608, number of apertures in the lid alignment plate 618) to support the number of containers that can simultaneously receive a lid would be altered to support that number of containers.

Referring to FIG. 6D, a single lid 622 of a corresponding stack of a plurality of lids is shown in a buffer lid storage receptacle 608. As can be seen, the lid 622 rests in the buffer lid storage receptacle 608 as the lid releaser plate 602 is in the lid lock position. Referring to FIG. 6E, the single lid of the corresponding stack of the plurality of lids has been released from the buffer lid storage receptacle 608 when the lid releaser plate 602 was moved to the lid release position.

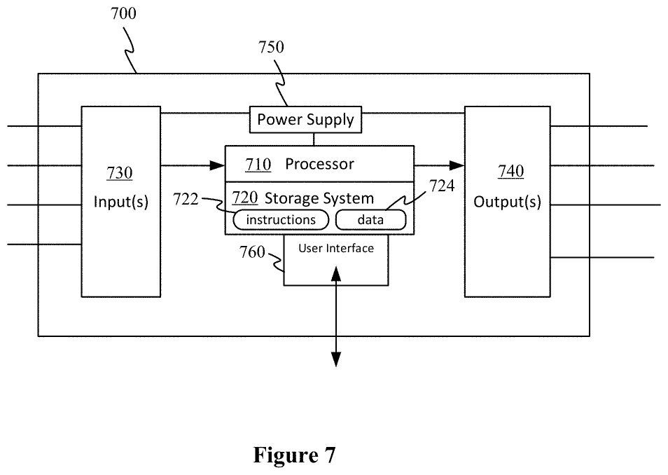

FIG. 7 illustrates a schematic representation of an example controller. Referring to FIG. 7, a controller 700 can include a processor 710; a storage system 720 storing instructions 722; an input interface 730; and an output interface 740. The controller can also include a power supply 750 (e.g., a battery and/or AC to DC converter) and a user interface 760. The controller can also include a timer (not shown).

The input interface 730 can receive signals from sensors such as an inert gas sensor, lid sleeve sensor, and proximity sensor. Other inputs can be received via the input interface 730 directly or via other interfaces such as a network interface (not shown) and user interface 760. The processor 710 processes the received signals according to the instructions 722 stored at the storage system 720 and outputs control signals to the output interface 740. The output interface 740 may be coupled to elements such as, but not limited to, motors and actuators for implementing the method 400 and the functionality described with respect to FIGS. 3A-3C.

The storage system 720 can be one or more of any suitable storage medium including volatile (e.g., random access memory such as DRAM and SRAM) and non-volatile memory (e.g., flash memory, ferroelectric or magnetic random-access memory). As mentioned above, the storage system 720 can include the instructions 722 and data 724, including any data received by an input to the controller that is used by the controller 700. The instructions 722 stored at the storage system can, when executed by the processor 710, direct the controller 700 to perform methods such as described herein, including method 400 such as described with respect to FIG. 4. In some cases, an operating system can be included as executable instructions stored on the storage system 720.

As used herein “storage media” do not consist of transitory, propagating waves. Instead, “storage media” refers to non-transitory media. In some cases, a communication system is also included as part of the controller 700. The communication system can include a network interface for coupling to the Internet or cellular service (e.g., for communicating with a service tied to a mobile application on a mobile device) and/or a short-range interface (near field, wide band, or other common communication protocols) that can be used to communicate wirelessly with nearby devices. In some cases, sensors may also be in communication with the controller via input interface 730 and/or output interface 740 (or general interfaces such as USB or firewire).

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A lid apparatus comprising:
a lid releaser plate comprising a plurality of lid apertures, wherein each lid aperture of the lid releaser plate abuts a bottom of a corresponding stack of a plurality of lids; and
an actuator coupled to the lid releaser plate that moves the lid releaser plate between a lid lock position and a lid release position.

2. The lid apparatus of claim 1, further comprising a plurality of lid sleeves, wherein each lid sleeve is configured to hold the corresponding stack of the plurality of lids.

3. The lid apparatus of claim 2, further comprising a plurality of buffer lid storage receptacles, wherein each buffer lid storage receptacle is coupled to a corresponding lid sleeve of the plurality of lid sleeves, wherein each of the plurality of buffer lid storage receptacles is configured to hold a buffer portion of the corresponding stack of the plurality of lids from the corresponding lid sleeve of the plurality of lid sleeves.

4. The lid apparatus of claim 3, wherein for each lid sleeve of the plurality of lid sleeves and its corresponding buffer lid storage receptacle of the plurality of buffer lid storage receptacles, when the actuator moves the lid releaser plate to the lid release position, a first lid of the buffer portion of the corresponding stack of the plurality of lids is released from that buffer lid storage receptacle onto a container and a second lid of the corresponding stack of the plurality of lids moves from the corresponding lid sleeve to that buffer lid storage receptacle.

5. The lid apparatus of claim 4, wherein during operation, each of the plurality of lid sleeves is detachable from its corresponding buffer lid storage receptacle for refilling with additional lids.

6. The lid apparatus of claim 1, wherein the lid releaser plate directs a single lid from each corresponding stack of the plurality of lids to be released through a lid aperture of the plurality of lid apertures of the lid releaser plate.

7. The lid apparatus of claim 6, wherein the actuator moves the lid releaser plate to the lid release position for a period of time sufficient for the single lid from each corresponding stack of the plurality of lids to be released.

8. The lid apparatus of claim 6, wherein movement of the lid releaser plate from the lid lock position to the lid release position causes the single lid from each corresponding stack of the plurality of lids to be released by separating the single lid from each from each corresponding stack of the plurality of lids.

9. The lid apparatus of claim 6, wherein when the actuator moves the lid releaser plate to the lid lock position, the single lid from each corresponding stack of the plurality of lids is prevented from being released through a lid aperture of the plurality of lid apertures of the lid releaser plate.

10. A canning system comprising:
a filling station for filling a plurality of containers with product;
a lid placement station comprising a lid apparatus configured to simultaneously place a single lid on each of the plurality of containers in the lid placement station; and
a push plate configured to move the plurality of containers from the filling station to the lid placement station.

11. The canning system of claim 10, wherein the push plate comprises a first plate coupled to a first actuator.

12. The canning system of claim 11, wherein the first plate is pushed, via the first actuator, against a side of each of the plurality of containers from the filling station to the lid placement station.

13. The canning system of claim 12, wherein the push plate comprises a second plate coupled to a second actuator.

14. The canning system of claim 13, wherein the second plate is positioned, via the second actuator, against the side of each of the plurality of containers after the first plate pushes the side of each of the plurality of containers from the filling station to the lid placement station.

15. The canning system of claim 10, further comprising an inert gas manifold configured to simultaneously release inert gas over each of the plurality of containers in the lid placement station prior to the lid apparatus simultaneously placing the lid on each of the plurality of containers.

16. The canning system of claim 10, further comprising a canning system controller, wherein the lid apparatus comprises a first actuator and a lid releaser plate coupled to the first actuator,
wherein the canning system controller sends a first signal to the first actuator to move the lid releaser plate of the lid apparatus from a lid lock position to a lid release position to simultaneously place the single lid on each of the plurality of containers in the lid placement station.

17. The canning system of claim 16, wherein the push plate comprises a second actuator and a first plate coupled to the second actuator,
wherein the canning system controller sends a second signal to the second actuator to push the first plate of the push plate against a side of each of the plurality of containers to move the plurality of containers from the filling station to the lid placement station after the plurality of containers have been filled with product by the filling station.

18. The canning system of claim 17, wherein the push plate further comprises a third actuator and a second plate coupled to the third actuator,
wherein the canning system controller sends a third signal to the third actuator to position a second plate of the push plate against the side of each of the plurality of containers after the first push plate pushes the side of each of the plurality of containers to move each of the plurality of containers from the filling station to the lid placement station.

19. The canning system of claim 16, further comprising an inert gas manifold, wherein the canning system controller sends a fourth signal to the inert gas manifold to simultaneously release inert gas over each of the plurality of containers in the lid placement station prior to sending the first signal to move the lid releaser plate of the lid apparatus from the lid lock position to the lid release position.

20. The canning system of claim 16, further comprising a container removal apparatus, wherein the canning system controller sends a fifth signal to the container removal apparatus to remove the plurality of containers from the lid placement station.
